(19) United States
(12) Patent Application Publication
(10) Pub. No.: US 2007/0259300 A1
(43) Pub. Date: Nov. 8, 2007

(54) ORTHODONTIC BRACE WITH COORDINATED BRACKET PROFILES

(75) Inventors: Richard P. McLaughlin, San Diego, CA (US); Ming-Lai Lai, Arcadia, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/381,565

(22) Filed: May 4, 2006

(51) Int. Cl. A61C 3/00

(52) U.S. Cl. 433/8

(57) ABSTRACT

A set of orthodontic brackets is constructed according to preferred parameters of a Deviation Index in order to provide an orthodontic brace that facilitates movement of teeth to ideal positions. The brace also helps eliminate the need to manually bend the archwire during the final stages of treatment such that chair time is reduced.

### BACKGROUND OF THE INVENTION

1. Field of the Invention

This invention broadly relates to a brace used in orthodontic treatment for correcting malocclusions. More particularly, the present invention relates to an orthodontic brace that includes a set of brackets having certain dimensional characteristics that are coordinated with one another to move the patient's teeth to optimal positions without the need for bending an archwire.

2. Description of the Related Art

Orthodontic treatment is often recommended for dental patients having teeth that are improperly positioned. Orthodontic treatment can greatly improve the aesthetic appearance of the patient, especially in regions near the front of the oral cavity. Orthodontic treatment can also enhance the function of the teeth by enabling opposing teeth to better interact with each other during mastication.

One type of common orthodontic treatment involves the use of a set of tiny appliances commonly known as brackets. Each of the brackets is secured to a corresponding tooth and has a slot to receive a resilient archwire. The slot forms a track to guide movement of the teeth to desired positions. Ends of the archwire are commonly placed in slots or channels of buccal tube appliances that are mounted on the patient's molar teeth. Molar teeth have relatively large roots and consequently provide good anchorage for various forces that may be exerted on the dental arch during orthodontic treatment.

In the past, orthodontic treatment was often carried out by forming bends, twists and loops in the archwire as needed for each tooth. The practitioner would then rely on the inherent resiliency of the archwire to urge the teeth to desired locations and proper angular orientations. However, the practice of custom-forming an archwire according to the particular malocclusion of the patient represents a significant expenditure of the practitioner's time. Moreover, considerable skill is needed to bend an archwire to an exact configuration sufficient to guide the teeth to desired positions.

In more recent times, the use of pre-adjusted orthodontic appliances has enjoyed widespread popularity. Pre-adjusted appliances are constructed with archwire slots or passages that extend at a certain, pre-selected orientation relative to the base of the appliance. This orientation varies from tooth to tooth, and is selected to help ensure that each tooth is in the desired orientation when the archwire slots or passages of all of the appliances extend in a common plane that is parallel to the occlusal plane at the conclusion of treatment. As a result, fewer custom-made bends are needed to be placed in the archwire by the practitioner.

### SUMMARY OF THE INVENTION

The present invention relates to an orthodontic brace that comprises a set of brackets constructed for optimizing the positions of the teeth at the conclusion of treatment. The dimensional characteristics of the brackets are, in particular, the “in-out” dimensions of the brackets are selected to help move the patient's teeth toward optimal positions and eliminate the need for placing custom bends, twists or loops in the archwire. As a result, the present invention provides a significant savings of time for both the practitioner and the patient.

In more detail, the present invention in one aspect relates to an orthodontic brace for a dental arch comprising a set of brackets. The set includes a lateral anterior bracket, a cuspid bracket and a first bicuspid bracket. Each of the brackets of the set has an archwire slot for receiving an archwire. The Deviation Index for the set of brackets is in the range of about 2 mm² to about 10 mm².

Another aspect of the invention is directed toward an orthodontic brace for an upper dental arch that comprises a set of brackets. The set includes an upper lateral anterior bracket, an upper first cuspid bracket and an upper first bicuspid bracket. Each of the brackets of the set has an archwire slot for receiving an archwire. The Deviation Index for the set of brackets is in the range of about 1 mm² to about 10 mm².

These and other aspects of the invention will be described in the paragraphs that follow and are illustrated in the accompanying drawings.

### BRIEF DESCRIPTION OF THE DRAWINGS

FIG. 1 is a front elevational view of an exemplary upper and lower dental arch of a patient undergoing orthodontic treatment with an upper and lower brace of the present invention;

FIG. 2 is a top view of the lower dental arch and lower brace illustrated in FIG. 1;

FIG. 3 is an enlarged side elevational view of an exemplary orthodontic bracket of the upper brace shown in FIG. 1;

FIG. 4 is a diagram showing an outline of the teeth of the upper dental arch depicted in FIG. 1 along with an embrasure line and the path of an archwire of the brace;

FIG. 5 is a graph depicting the distance relationship between the bottom of the archwire slot and the embrasure line for the brackets of the lower arch brace depicted in FIG. 1 as well as for the brackets of lower arch braces previously known in the art;

FIG. 6 is a graph somewhat similar to FIG. 5 except that the brackets are for an upper brace for an upper dental arch;

FIG. 7 is a graph depicting the Deviation Index for an upper dental arch brace of the present invention as well as for various upper arch dental braces known in the art; and

FIG. 8 is a view somewhat similar to FIG. 7 except that the braces are for a lower dental arch.

### DETAILED DESCRIPTION OF THE PREFERRED EMBODIMENTS

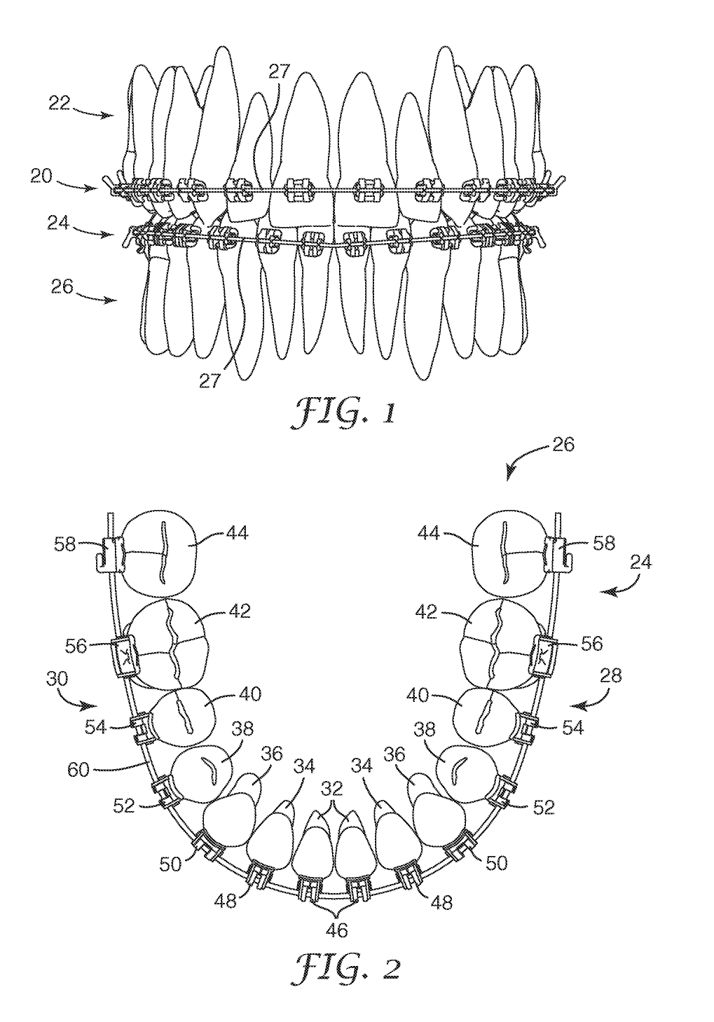

FIG. 1 illustrates an example of an oral cavity of an orthodontic patient who is undergoing orthodontic therapy. The patient has an upper orthodontic brace 20 that is connected to the teeth of the patient's upper dental arch 22 and a lower orthodontic brace 24 that is connected to the teeth of the patient's lower dental arch 26. Each brace 20, 24 includes a set of orthodontic appliances along with an archwire 27 that is received in slots of the appliances, as will be described in more detail below.

FIG. 2 is an enlarged view of the lower dental arch 26 along with the lower brace 24, looking in an downwardly direction toward the outer or occlusal tips of the patient's teeth. The lower dental arch 26 includes a left dental quadrant 28 and a right dental quadrant 30. Each of the quadrants 28, 30 includes a lower central anterior tooth 32, a lower lateral anterior tooth 34, a cuspid tooth 36, a lower first bicuspid tooth 38 and a lower second bicuspid tooth 40. In addition, each of the quadrants 28, 30 includes a first molar tooth 42 and a second molar tooth 44.

The illustration of the lower dental arch 26 shown in FIGS. 1 and 2 is only one example of dentition, and many variations are possible. For example, the patient may lack one or more of the illustrated teeth, as may occur in adolescent patients when some of the permanent teeth have not yet erupted. Alternatively, one or more teeth may have been removed prior to orthodontic treatment in order to reduce crowding, especially in instances where the overall size of the dental arch is relatively small. Moreover, the lower dental arch 26 may include third molar teeth, also known as wisdom teeth which are not illustrated in the drawings.

The lower brace 24 includes a set of appliances connected to the teeth of the lower quadrants 28, 30. In particular, the lower brace 24 in each of the quadrants 28, 30 includes a lower central bracket 46 that is connected to the lower central tooth 32, and a lower bracket 48 that is connected to the lower lateral tooth 34, a lower cuspid bracket 50 that is connected to the lower cuspid tooth 36, a lower first bicuspid bracket 52 that is connected to the lower first bicuspid tooth 38 and a lower second bicuspid bracket 54 that is connected to the lower second bicuspid tooth 40. In this example, the lower brace 24 also includes in each of the quadrants 28, 30 a lower first molar buccal tube 56 that is connected to the lower first molar tooth 42 and a lower second molar buccal tube 58 that is connected to the lower second molar tooth 44.

Optionally, one or more of the brackets or buccal tubes described above may be omitted in accordance with the preferences of the orthodontist. For example, if the second molar teeth 44 have not yet fully erupted, the practitioner may elect to omit the buccal tubes 58, at least during the early stages of treatment. Optionally, the first molar buccal tubes 56 may be of the “convertible” types that have a cap that can be removed during the course of treatment in order to convert the buccal tube to a bracket.

The archwire 27 of the lower brace 24 is made of a resilient material. Suitable materials include, for example, metallic materials such as alloys of nitinol and stainless steel. The archwire 27 has a generally overall “U”-shaped configuration and extends along both of the quadrants 28, 30. The archwire 27 is received in slots of the brackets 46, 48, 50, 52 and 54 and in passages of the buccal tubes 56, 58.

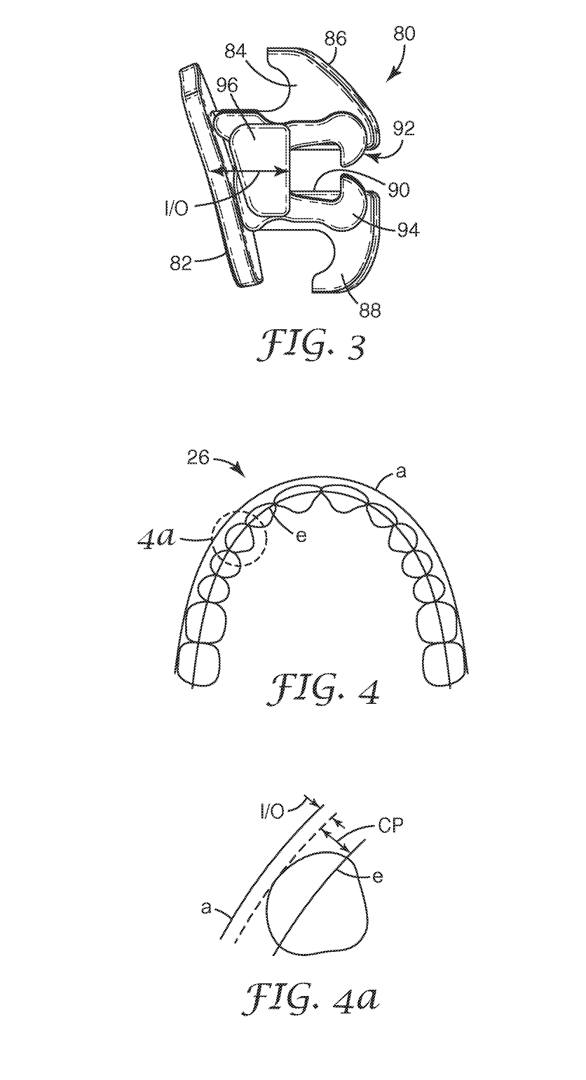

An exemplary orthodontic bracket 80 is shown in FIG. 3 in side elevational view. In this instance, the bracket 80 is intended for mounting on the enamel surface of an upper central incisor tooth. The bracket 80 includes a base 82 for bonding the bracket 80 directly to the patient's tooth enamel by use of an adhesive. A body 84 of the bracket 80 extends outwardly from the base 82 in a generally buccolabial direction. The body 84 in this embodiment includes a spaced-apart pair of gingival tiewings 86 and a spaced-apart pair of occlusal tiewings 88. An archwire slot 90 extends across the body 84 in a generally mesial-distal direction and along the space presented between the gingival tiewings 86 and the occlusal tiewings 88.

In this example, the bracket 80 is a self-ligating bracket having a latch 92 for releasably retaining an archwire in the archwire slot 90. The latch 92 includes a distal clip 94 as well as a mesial clip that is not shown in the drawings. The distal clip 94 has an overall, generally “C”-shaped configuration and is held in place by a support 96 that extends outwardly from the body 84 in a distal direction.

Further details regarding the exemplary bracket 80 including the latch 92 as well as other aspects are set out in pending U.S. patent application Ser. No. 11/050,615, filed Feb. 2, 2005 and entitled “PRE-TORQUED ORTHODONTIC APPLIANCE WITH ARCHWIRE RETAINING LATCH”. However, other brackets are also possible. For example, the bracket 80 may be replaced by a bracket that is not self-ligating. As yet another option, the bracket may be made of metal (such as alloys of stainless steel or other metallic materials), ceramic materials (including monocrystalline and polycrystalline light-transmitting ceramics) and polymeric materials (such as fiber-reinforced polycarbonate).

In FIG. 3, the in-out dimension of the bracket 80 is designated by the notation “I/O”. The in-out dimension is the distance between the bottom or lingual side of the archwire slot 90 and the exterior surface of the base 82, measured along a reference axis that is perpendicular to the bottom of the archwire slot 90 and passes through the mesial-distal and occlusal-gingival center of the archwire slot 90.

FIG. 4 is a diagram showing an outline of the teeth of the upper dental arch 22, along with a first curve representing an embrasure line and a second curve representing the path of a lingual side of the upper archwire 27. The embrasure line is designated by the letter “e” in FIG. 4 for the exemplary upper dental arch 22. The embrasure line is an imaginary curve, located at the level of the tooth crown's midtransverse plane that connects the most facial portions of the contact areas of all of the tooth crowns in the upper dental arch 22 when the teeth are in desired orientations.

The letter “a” in FIG. 4 represents the path of the lingual side of the archwire such as archwire 27. The archwire path “a” illustrates the configuration of the lingual side of the archwire when the teeth are in their ideal or finished positions and when the lingual side of the archwire is seated against the bottom or lingual wall of the archwire slot, such as archwire slot 90.

FIG. 4a is an enlarged view of a portion of FIG. 4, depicting the relationship between the archwire path “a”, the embrasure line “e”, the in-out dimension I/O and the crown prominence (“CP”) for one of the upper teeth. The in-out dimension, or I/O, is described above. The crown prominence “CP” is the distance in a buccolabial direction from the embrasure line “e” to each crown's most prominent facial point.

Preferably, each of the brackets of the upper and lower braces 20, 24 is pre-adjusted for torque and angulation. Tooth angulation may be defined according to the teachings of Dr. Lawrence F. Andrews as the mesiodistal cant of the facial axis of the clinical crown (“FACC”) relative to a line perpendicular to the occlusal plane (see, e.g., Straight Wire, The Concept and Appliance, by Lawrence F. Andrews, (L. A. Wells Co., ©1989)). Bracket angulation may be defined as the particular angular orientation of the archwire slot of the bracket relative to the base of the bracket in order to provide tooth angulation.

Tooth torque may be defined as the buccolabial-lingual cant of the FACC when measured from a line perpendicular to the occlusal plane. Consequently, bracket torque may be defined as the orientation of the archwire slot relative to the base of the bracket such that the desired tooth torque is attained.

Table I sets out the crown prominence “CP” as determined by Dr. Andrews for teeth of the upper or maxillary arch along with preferred values according to the present invention for in/out, torque and angulation. Table II is a table similar to Table I except that Table II is directed to the lower or mandibular arch.

TABLE I
Maxillary Arch

| | | | | 1^{st} | 2^{nd} | 1^{st} | 2^{nd} |
|---|---|---|---|---|---|---|---|
| | Central | Lateral | Cuspid | Bicuspid | Bicuspid | Molar | Molar |
| Andrews | 2.1 | 1.65 | 2.5 | 2.4 | 2.5 | 2.9 | 2.9 |
| Crown | | | | | | | |
| Prominence, | | | | | | | |
| mm | | | | | | | |
| torque, | 17 | 10 | −7, +7 or 0 | −7 | −7 | −14 | −14 |
| degrees | | | | | | | |
| angulation, | 4 | 8 | 8 | 0 | 0 | 0 | 0 |
| degrees | | | | | | | |

TABLE II
Mandibular Arch

| | | | | 1^{st} | 2^{nd} | 1^{st} | 2^{nd} |
|---|---|---|---|---|---|---|---|
| | Central | Lateral | Cuspid | Bicuspid | Bicuspid | Molar | Molar |
| Andrews | 1.2 | 1.2 | 1.9 | 2.35 | 2.35 | 2.5 | 2.5 |
| Crown | | | | | | | |
| Prominence, | | | | | | | |
| mm | | | | | | | |
| torque, | −6 | −6 | −6, +6 or 0 | −12 | −17 | −20 | −10 |
| degrees | | | | | | | |
| angulation, | 0 | 0 | 3 | 2 | 2 | 0 | 0 |
| degrees | | | | | | | |

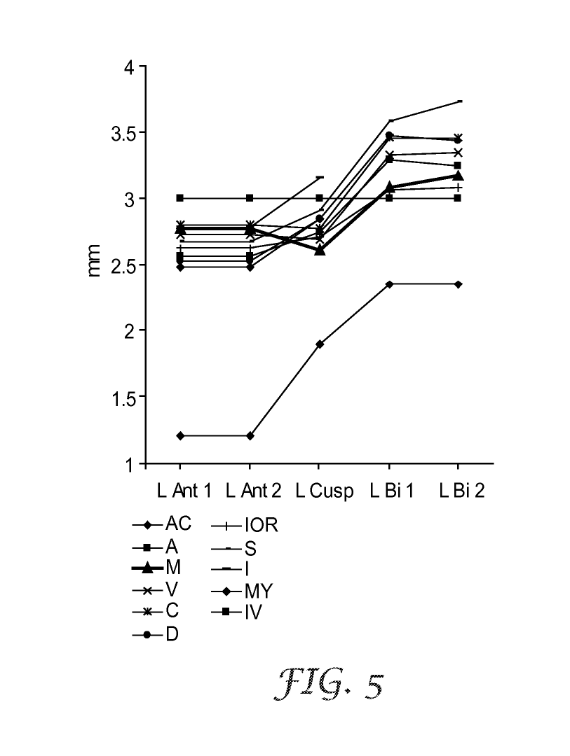

FIG. 5 is a graph depicting the relationship of the distance between the bottom of the archwire slot and the embrasure line (“S/E”) for the brackets of the brace 24 for the patient's lower arch 26. In FIG. 5, this relationship for the present invention is designated by the graph identified by the letter “M”. In FIG. 5, the designation “L Ant 1” refers to the lower central anterior bracket, “L Ant 2” refers to the lower lateral anterior bracket, “L Cusp” refers to the lower cuspid bracket, “L Bi 1” refers to the lower first bicuspid bracket, and “L Bi 2” refers to the lower second bicuspid bracket. For each bracket, the values are identical for the left and right quadrants.

FIG. 5 also shows the S/E distance for this relationship for several brackets systems known in the art including Victory Series brand bracket systems (“V”) and Clarity brand bracket system (“C”), both from 3M Unitek Corporation. FIG. 5 also shows the S/E distance for the Damon 3 brand bracket system (“D”) from Ormco Corporation, In-ovation R brand bracket system (“IOR”) from GAC International, Inc., Speed brand bracket system (“S”) from Strite Industries, Inspire Ice brand bracket system (“I”) from Ormco Corporation, Mystic brand bracket systems (“MY”) from GAC International, Inc., and InVu brand bracket systems (“IV”) from TP Orthodontics, Inc. In connection with the latter bracket systems, sample brackets were measured to determine the I/O for calculation of S/E values.

For purposes of comparison, the values for S/E as proposed by Dr. Andrews are identified in FIG. 5 by the graph designated with the letter “A”. Additionally, the values for crown prominence as proposed by Dr. Andrews are designated by the graph identified “AC” in FIG. 5. Importantly, the distance from the bottom of the archwire slot to the embrasure line S/E) is greater for the lower lateral anterior bracket than the lower cuspid bracket. The S/E value for the lower lateral anterior bracket is preferably greater than 0.1 mm, and more preferably is greater than 0.15 mm, than the S/E value for the lower cuspid bracket. This is in contrast to many known bracket systems wherein the S/E value for the lower lateral anterior bracket is less than the S/E value for the lower cuspid bracket.

Additionally, the S/E value for the lower first bicuspid bracket is preferably less than the S/E value for the lower second bicuspid bracket. The S/E value for the lower first bicuspid bracket is preferably about 0.15 mm less than the S/E value for the lower second bicuspid bracket.

Preferably, the in-out dimension or “I/O”, for the lateral anterior bracket is greater than the I/O value for the cuspid bracket. Preferably, the I/O value for the lateral anterior bracket is at least 0.9 mm greater than the I/O value for the lower cuspid bracket.

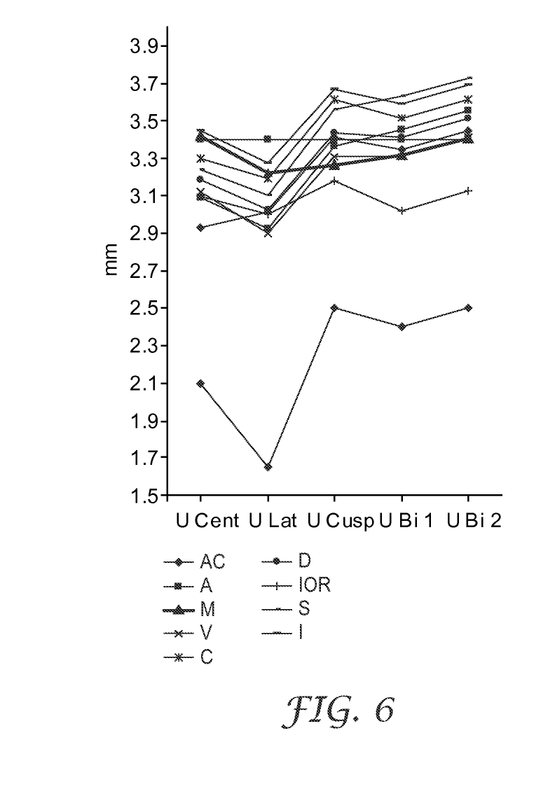

FIG. 6 is a graph somewhat similar to FIG. 5 except that the values are provided for an upper brace of the present invention as well as, for comparative purposes, upper braces of known bracket systems. The designations used in FIG. 6 are the same as the designations used in FIG. 5 in addition.

As shown in FIG. 6, the difference in the S/E values for the upper lateral bracket and the upper cuspid bracket of the brace of the present invention is significantly different than the difference of the S/E values for the upper lateral bracket and upper cuspid brackets of known bracket system known in the art. The S/E value for the upper lateral bracket is preferably less than about 0.35 mm, more preferably less than about 0.2 mm and most preferably less than about 0.1 mm than the S/E value for the upper cuspid bracket.

In addition, the S/E value for the upper lateral anterior bracket of the present invention is less than the S/E value for the upper central anterior bracket of the present invention. The S/E value for the upper cuspid bracket is greater than the S/E value for the lateral anterior bracket. In instances where the brace includes an upper second bicuspid bracket, the S/E value for the upper second bicuspid bracket is equal to or greater than the S/E value for the upper first bicuspid bracket.

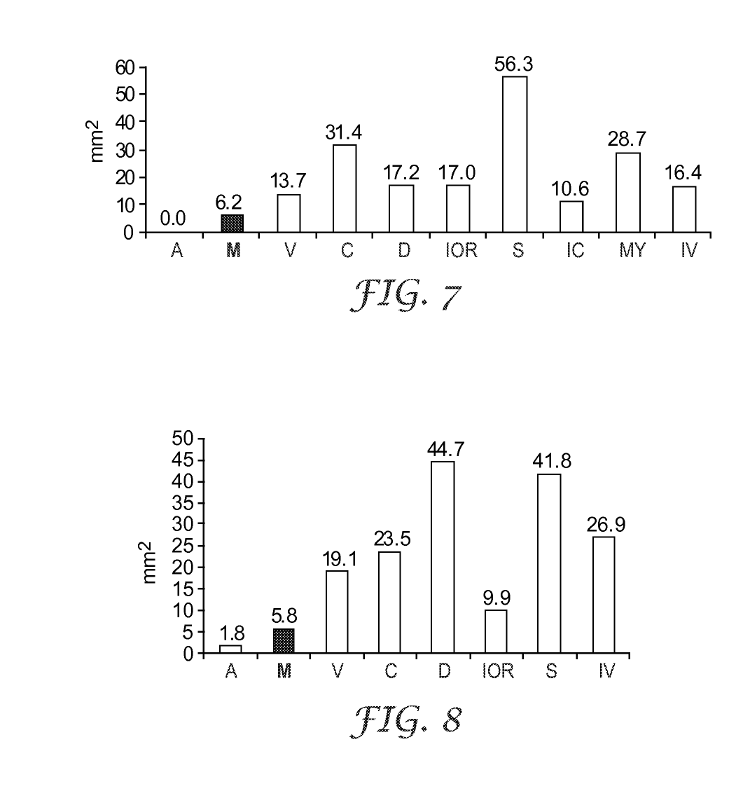

FIG. 7 is a graph depicting the Deviation Index for an upper dental arch brace of the present invention as well as the Deviation Index for various upper arch dental braces known in the art. The Deviation Index “D” is created to evaluate the degree of deviation from a “straight” archwire as follows:

$${D}_{2 - 4} = 100 {\sum }_{i = 2}^{4} {( {c}_{i} - {c}_{avg} )}^{2}$$

where cᵢ is the S/E distance that is equal to the crown prominence (CP, as determined by Dr. Andrews as set out above) plus the in/out (S/E, or slot to crown prominence) for i tooth (2=lateral, 3=cuspid, 4=first bicuspid) and c_{avg} is the average.

As shown in FIG. 7, the Deviation Index for an upper dental arch brace of the present invention is about 6.2 mm². Preferably, the Deviation Index for the upper dental arch brace is in the range of about 2 mm² to about 10 mm², and more preferably is in the range of about 3 mm² to about 9 mm², and most preferably is in the range of about 4 mm² to about 8 mm².

FIG. 8 is a graph depicting the Deviation Index for a lower dental arch brace of the present invention as well as the Deviation Index for various lower arch dental braces known in the art. However, for the lower dental arch, the S/E distance for the bracket of the lower cuspid tooth should be about 0.2 mm less than the S/E distance of the lower lateral bracket for the lower lateral tooth. Consequently, in order to calculate the Deviation Index for the lower dental arch, the S/E distance for the lower cuspid bracket is c₃=c_{3,actual}+0.2 where c_{3,actual} is the actual S/E value.

As illustrated in FIG. 8, the Deviation Index for the lower dental arch brace of the present invention is about 5.8 mm², in contrast to the significantly higher deviation indices of the lower dental arch braces currently known in the art. Preferably, the Deviation Index for the lower arch dental brace is in the range of about 2 mm² to about 10 mm², more preferably is in the range of about 3 mm² to about 9 mm², and most preferably is in the range of about 4 mm² to about 8 mm².

The bracket sets of the present invention provide a significant improvement over sets of brackets previously known in the art. For example, in connection with the bracket sets proposed by Dr. Andrews, many practitioners believe that the anterior brackets are too “thick”, i.e. have excessive in-out dimensions which lead to patient discomfort and sometimes interfere with the brackets mounted on opposing teeth. However, commercially available brackets are often considered not entirely satisfactory because the final tooth positions are less than ideal. Often, for example, the final position of the cuspid tooth is observed to be out of ideal alignment with adjacent teeth. By contrast, however, the bracket sets of the present invention help ensure that the final position of the cuspid tooth is more satisfactory, while patient discomfort and bracket interference are avoided. Moreover, the bracket sets of the present invention have sufficient thickness in an in-out direction to help avoid fracture during manufacture and use, even when relatively brittle materials such as ceramic materials are employed.

In some instances, the practitioner may prefer to extract the first bicuspid teeth. In these instances, the second bicuspid teeth shall be considered as first bicuspid teeth, and the values set out above and in the following claims relating to the Deviation Index, the S/E values and the in-out dimensions of brackets for the first bicuspid tooth shall be interpreted to mean values for brackets for the second bicuspid teeth.

1. An orthodontic brace for a dental arch comprising a set of brackets, the set including a lateral anterior bracket, a cuspid bracket and a first bicuspid bracket, wherein each of the brackets of the set has an archwire slot for receiving an archwire, and wherein the Deviation Index for the set of brackets is in the range of about 2 mm² to about 10 mm².

2. An orthodontic brace according to claim 1 wherein the Deviation Index for the set of brackets is in the range of about 3 mm² to about 9 mm².

3. An orthodontic brace according to claim 1 wherein the Deviation Index for the set of brackets is in the range of about 4 mm² to about 8 mm².

4. An orthodontic brace according to claim 1 wherein the brace is an upper brace for the dental arch, wherein the set of brackets also includes an upper central anterior bracket, wherein the archwire slot of each bracket has a bottom surface, wherein each of the brackets is constructed with a certain dimension “S/E” that represents the difference in the dimension between the bottom surface of the archwire slot and the embrasure line, wherein the “S/E” dimension for the lateral anterior bracket is less than the “S/E” dimension for the central anterior bracket, wherein the “S/E” dimension for the cuspid bracket is greater than the “S/E” dimension for the lateral anterior bracket, wherein the “S/E” dimension for the first bicuspid bracket is greater than the “S/E” dimension for the cuspid bracket and wherein each “S/E” dimension is less than about 3.4 mm.

5. An orthodontic brace according to claim 4 wherein the set of brackets also includes an upper second bicuspid bracket, and wherein the “S/E” dimension is greater for the second bicuspid bracket than the “S/E” dimension for the first bicuspid bracket.

6. An orthodontic brace according to claim 4 wherein the difference between the “S/E” dimension for the lateral anterior bracket and the S/E dimension for the cuspid bracket is less than about 0.25 mm.

7. An orthodontic brace according to claim 1 wherein each of the brackets is constructed with a certain in-out dimension, and wherein the in-out dimension of the lateral anterior bracket is greater than about 0.80 mm of the in-out dimension of the cuspid bracket.

8. An orthodontic brace according to claim 1, wherein the brace is a lower brace for the lower dental arch, wherein the set of orthodontic brackets also includes a lower cuspid bracket, wherein the archwire slot of each bracket has a bottom surface, wherein each of the brackets is constructed with a certain “S/E” dimension that represents the difference in the dimension between the bottom surface of the archwire slot and the embrasure line, wherein the “S/E” dimension for the cuspid bracket is less than the “S/E” dimension for the lateral anterior bracket, wherein the “S/E” dimension for the first bicuspid bracket is greater than the “S/E” dimension for the cuspid bracket, and wherein the “S/E” dimension for the second bicuspid bracket is greater than the “S/E” dimension for the first bicuspid bracket.

9. An orthodontic brace according to claim 8 wherein the difference in the “S/E” dimension between the cuspid bracket and the lateral anterior bracket is less than 0.40 mm.

10. An orthodontic brace according to claim 8 wherein the “S/E” dimension for the lower cuspid bracket is about 0.20 mm less than the “S/E” dimension for the lateral anterior bracket.

11. An orthodontic brace according to claim 8 wherein the “S/E” dimension for the first bicuspid bracket is about 0.15 mm less than the “S/E” dimension for the second bicuspid bracket.

12. An orthodontic brace according to claim 8, wherein the set of orthodontic brackets also includes a cuspid bracket, wherein each of the brackets is constructed with a certain in-out dimension and wherein the in-out dimension of the lateral anterior bracket is about 0.9 mm greater than the in-out dimension of the cuspid bracket.

13. An orthodontic brace according to claim 1 wherein the brackets include a body comprising a ceramic material.

14. An orthodontic brace according to claim 1 wherein the brackets include a body comprising a metallic material.

15. An orthodontic brace according to claim 1 wherein the brackets include a body comprising a polymeric material.

16. An orthodontic brace for an upper dental arch comprising a set of brackets, the set including an upper lateral anterior bracket, an upper cuspid bracket and an upper first bicuspid bracket, wherein each of the brackets of the set has an archwire slot for receiving an archwire, and wherein the Deviation Index for the set of brackets is in the range of about 1 mm² to about 10 mm².

17. An orthodontic brace according to claim 11 wherein the Deviation Index for the set of brackets is in the range of about 3 mm² to about 9 mm².

18. An orthodontic brace according to claim 11 wherein the Deviation Index for the set of brackets is in the range of about 4 mm² to about 8 mm².
